(19) United States
(12) Patent Application Publication
(10) Pub. No.: US 2024/0418302 A1
(43) Pub. Date: Dec. 19, 2024

(54) CONVEX MALE FITTING AND SYSTEMS

(71) Applicant: CONTROLS SOUTHEAST, INC., Pineville, NC (US)

(72) Inventors: Brandon W. Forbes, Charlotte, NC (US); Andrew Steven Pustay, Waxhaw, NC (US)

(73) Assignee: CONTROLS SOUTHEAST, INC., Pineville, NC (US)

(21) Appl. No.: 18/817,180

(22) Filed: Aug. 27, 2024

Related U.S. Application Data
(63) Continuation of application No. 16/780,471, filed on Feb. 3, 2020, now abandoned.
(60) Provisional application No. 62/800,899, filed on Feb. 4, 2019.

(51) Int. Cl. F16L 15/08; F16L 15/04; F16L 19/02; F16L 37/10; F16L 59/18

(52) U.S. Cl. CPC F16L 15/08; F16L 15/04; F16L 19/0243; F16L 37/101; F16L 37/105; F16L 59/188

(57) ABSTRACT

Embodiments of the invention are directed to a male connector for establishing a line-seal for transport of fluids between pipes. The male connector is structured to increase a seating pressure of the line-seal. The male connector comprises a male portion provided at one end of the male connector. The male portion typically comprises a conical sealing frustum provided at one end of the male connector, such that the conical sealing frustum comprises convex sides. Moreover, the male connector is structured to be operatively coupled to a predetermined female connector such that the conical sealing frustum forms a substantially line-seal with the predetermined female connector for transport of a process fluid therethrough.

### CROSS REFERENCE AND PRIORITY CLAIM

The present Application for a Patent claims priority to co-pending U.S. application Ser. No. 16/780,471 entitled “Convex Male Fitting and Systems” filed on Feb. 3, 2020, which claims priority to U.S. Provisional Patent Application Ser. No. 62/800,899 entitled “Convex Male Fitting and Systems” filed on Feb. 4, 2019, both of which are assigned to the assignees hereof and hereby expressly incorporated by reference herein.

### FIELD

This application relates generally to the field of connectors for tubular components, and more particularly to an improved connector for joining tubular conduits. Specifically, embodiments of the invention are directed to a convex male connector, systems utilizing the convex male connector, and methods of configuring and using the same.

### BACKGROUND

Piping systems typically comprise a system of pipes used to convey fluids from one location to another. Such piping systems may be employed for a variety of fluids in a variety of applications such as for industrial, automotive, HVAC ducting and other applications. The piping systems typically comprise a network of pipes, tubes or other conduits for conveying fluids that may be made of metal, plastic, fiber, composites, or other materials. The piping systems typically require one or more fittings for operatively coupling a pair of conduits.

### BRIEF SUMMARY

Embodiments of the invention are directed to a connector assembly for establishing improved sealing between a male connector (e.g., a male fitting) and a female connector (e.g., female fitting), and in particular, in some embodiments an improved connector assembly having a line-seal. The connector assembly is structured to increase a seating pressure of the line-seal. The connector assembly comprises a male connector provided at one end of the connector assembly. The male connector typically comprises a male portion with a conical sealing frustum, such that the conical sealing frustum comprises convex sides. Moreover, the connector assembly is structured to be operatively coupled to a female connector such that the conical sealing frustum of the male portion forms a line-seal with the female portion of the female connector to allow transport of a fluid therethrough.

One embodiment of the disclosure comprises, male connector for establishing a line-seal for transport of fluids between pipes. The male connector is structured to increase a seating pressure. The male connector comprises a male portion provided at one end of the male connector. The male portion comprises a conical sealing frustum, and the conical sealing frustum comprises convex sides. The male connector is structured to be operatively coupled to a female connector such that the conical sealing frustum forms a substantially line-seal with the female connector for transport of a fluid therethrough.

In further accord with embodiments of the disclosure, the male connector is manufactured from a carbon steel material or a stainless steel material.

In other embodiments of the disclosure, the male connector comprises one or more layers applied to a least a portion of a surface of the male connector.

In still other embodiments of the disclosure, the one or more layers comprise a coating structured to improve predetermined surface properties of the male connector or a plating structured to improve the predetermined surface properties of the male connector, thereby providing predetermined enhanced sealing performance.

In yet other embodiments of the disclosure, the fluid, is steam, hot oil, or a predetermined mixture comprising water and glycol.

In other embodiments of the disclosure, the male connector is structured for conveying the fluid to and from heat tracer pipes and heating jackets, wherein the fluid is a heating fluid.

In further accord with embodiments of the disclosure, the male connector is structured for operatively connecting a flexible metal hose to consecutive heat tracing pipes or heat tracing jacket components.

In other embodiments of the disclosure, the male connector is coupled to a process pipe.

In still other embodiments of the disclosure, the male connector is associated with a minimum seating torque for establishing the substantially line-seal having a standard deviation of less than 20.

Another embodiment of the disclosure comprises a connector assembly for establishing a line-seal for transport of fluids between pipes. The assembly comprises a male connector comprising a male portion provided at one end of the male connector. The male portion comprises a conical sealing frustum provided at one end of the male connector, and the conical sealing frustum comprises convex sides. The assembly further comprises a female connector comprising a female flange having a flange surface at one end of the female connector. The male connector is operatively coupled to the female connector such that the conical sealing frustum forms a substantially line-seal with the flange surface of the female connector for transport of a fluid therethrough.

In further accord with embodiments of the disclosure, the male connector comprises one or more layers applied to a least a portion of a surface of the male connector.

In other embodiments of the disclosure, the one or more layers comprise a coating structured to improve predetermined surface properties of the male connector or a plating structured to improve the predetermined surface properties of the male connector, thereby providing predetermined enhanced sealing performance.

In still other embodiments of the disclosure, the fluid is steam, hot oil, or a mixture comprising water and glycol.

In yet other embodiments of the disclosure, the male connector is structured for conveying the fluid to and from heat tracer pipes and heating jackets, wherein the fluid is a heating fluid.

In other embodiments of the disclosure, the male connector is structured for operatively connecting a flexible metal hose to consecutive heat tracing pipes or heat tracing jacket components.

In further accord with embodiments of the disclosure, the male connector is coupled to a process pipe.

In other embodiments of the disclosure, the male connector is associated with a minimum seating torque for establishing the substantially line-seal having a standard deviation of less than 20.

Another embodiment of the invention comprises a method for forming a connector assembly for establishing a line-seal for transport of fluids between pipes. The method comprises providing a male connector comprising a male portion provided at one end of the male connector. The male portion comprises a conical sealing frustum provided at one end of the male connector, and the conical sealing frustum comprises convex sides. The method further comprises providing a female connector comprising a female flange having a flange surface one end of the female connector. The method further comprises operatively coupling the male connector to the female connector such that the conical sealing frustum forms a substantially line-seal with the flange surface of the female connector for transport of a process fluid therethrough.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings.

FIG. 1 illustrates a side view 100 of a male connector, in accordance with some embodiments of the invention.

FIG. 2 illustrates a detailed sectional view 200 of a portion of the male connector of FIG. 1, in accordance with some embodiments of the invention.

FIG. 3 illustrates a detailed sectional view 300 of a portion of the male connector of FIG. 1, in accordance with some embodiments of the invention.

FIG. 4 illustrates a cross-sectional view 400 of a connector assembly, in accordance with some embodiments of the invention.

FIG. 5A illustrates a perspective view 500A of a process system incorporating jacketed pipes, in accordance with some embodiments of the invention.

FIG. 5B illustrates a schematic sectional view 500B of a jacketed pipe of FIG. 5A, in accordance with some embodiments of the invention.

FIG. 6A illustrates a perspective view 600A of a male connector installed at a jacketed pipe assembly, in accordance with some embodiments of the invention.

FIG. 6B illustrates a perspective view 600B of a connector assembly installed at a jacketed pipe assembly of FIG. 6A, in accordance with some embodiments of the invention.

FIG. 7 illustrates a perspective view 700 of a connection system, in accordance with some embodiments of the invention.

FIG. 8A illustrates a perspective view 800A of a tracer piping system, in accordance with some embodiments of the invention.

FIG. 8B illustrates a detailed sectional view 800B of a portion of the tracer piping system of FIG. 8A, in accordance with some embodiments of the invention.

FIG. 8C illustrates a detailed sectional view 800C of a portion of the tracer piping system of FIG. 8A, in accordance with some embodiments of the invention.

FIG. 9 illustrates a perspective view 900 of a valve heating jacket system, in accordance with some embodiments of the invention.

FIG. 10 illustrates a plot 1000 associated with non-limiting test results depicting improvements to seating torque requirements for establishing sealing, in accordance with some embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout. In some embodiments, like elements are indicated with like numbers in arithmetic progressions having a difference of 100 (e.g., 10, 110, 210, 310, etc.).

The following detailed description refers to the accompanying drawings, which illustrate specific embodiments. Other embodiments having different structures and operation do not depart from the scope of the present disclosure. Certain terminology is used herein for convenience only and is not to be taken as a limitation on the embodiments described. For example, words such as “top”, “bottom”, “upper,” “lower,” “left,” “right,” “horizontal,” “vertical,” “upward,” and “downward” merely describe the configuration shown in the figures. Indeed, the referenced components may be oriented in any direction and the terminology, therefore, should be understood as encompassing such variations unless specified otherwise. Throughout this disclosure, where a process or method is shown or described, the method may be performed in any order or simultaneously, unless it is clear from the context that the method depends on certain actions being performed first.

As discussed previously, piping systems typically comprise a system of pipes used to convey fluids from one location to another. Such piping systems may be employed for covering a variety of fluids in a variety of applications such as for industrial, automotive, HVAC ducting and other applications. The piping systems typically comprise a network of pipes for conveying fluids that may be made of metal, plastic, fiber, composites, or other materials. The piping systems typically require one or more connector assemblies for operatively coupling a pair of pipes, as will be discussed in further detail herein.

Conventional pipe connectors of a detachable type are typically only effective for transport of certain kinds of fluids and only for certain types of applications at certain pressures and/or temperatures. For example, the scaling (e.g., surface type sealing) provided by conventional pipe connectors may not be adequate for certain fluids (e.g., steam, hot oil, glycol, or the like) at certain pressures and temperatures, and/or in certain applications (e.g., tracer pipes, jacketed pipes, jacketed flanges, or the like). There exists a need for improved connector assemblies and connectors thereof for providing effective sealing for transporting of fluids, and that is compatible with the sealing requirements of a wide variety of fluids (e.g., steam, hot glycol and water-glycol mixture, or the like), and in particular at elevated pressures and/or temperatures.

The present invention alleviates the aforementioned concerns and provides a connector assembly, and a convex male connector in particular, for providing effective scaling, regulation and/or transport of fluids. The connector assembly described herein may provide improved connections for use with a wide variety of fluids such as steam, hot glycol and water-glycol mixture in particular, in a variety of applications (e.g., tracer pipes associated with liquid sulfur or hydrogen sulfide gas transport, jacketed pipes, high-performance, such as high-pressure, high-flow, high-temperature or hazardous-material, conveyance of fluids, jacketed flanges, or the like).

As used herein, a “pipe” may refer to a tubular elongate member with a predetermined cross-section (e.g., circular, oval, polygonal—such as triangular, square, rectangular, or the like, curvilinear, and/or a suitable combination of the foregoing, or the like, or generally or substantially any of the aforementioned shapes), for example a hollow tube, a hose, or the like. Moreover, as used herein, a “vessel” may be a hollow container, which may include a pipe.

A “connector” (e.g., male connector, female connector, or the like), as used herein, may refer to components that are configured for operatively coupling to a pipe to allow for operative coupling of two or more pipes. The connectors of the connector assemblies (e.g. connector assemblies 10, 110, or the like, described herein) may be manufactured from one or more materials selected from a group comprising: metals (e.g., steel, copper, aluminum, iron, alloys thereof, etc.), concrete, cement, plastics, composites, wood, fiberglass, glass, and/or other suitable materials, and may be the same material or a different material than the pipe associated with the connector.

A “fluid” as used herein may refer to a liquid, a gas, a vapor, a particulate suspension, a vapor suspension/aerosol, a colloid, an emulsion, a dispersion, a heterogeneous mixture/solution, a homogeneous mixture/solution, a gaseous mixture/solution, and/or a suitable combination thereof.

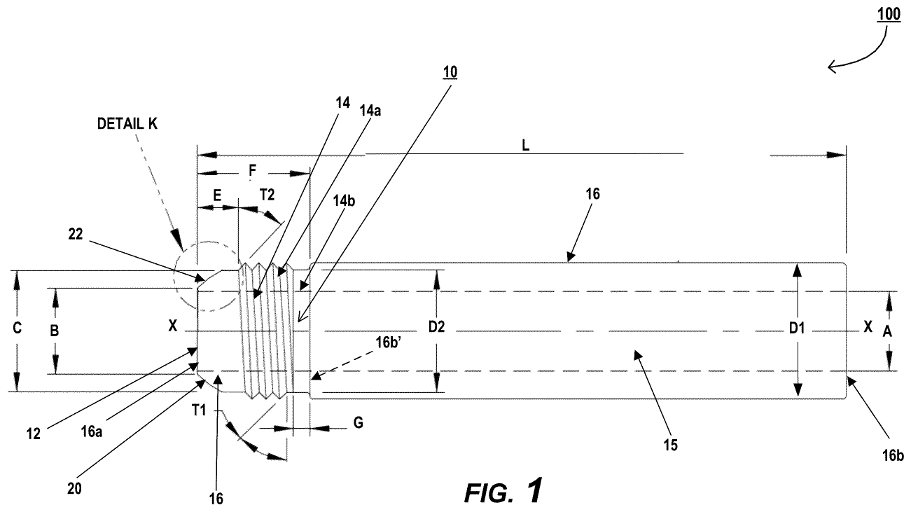

The connector assembly 90, connectors thereof, and systems in which the connector assemblies 90 are utilized will be described with respect to FIGS. 1-9 in accordance with embodiments of the invention. FIG. 1 illustrates a side view 100 of a male connector 10, in accordance with some embodiments of the invention. The male connector 10 comprises a connector body 16. The connector body 16 typically defines a coupling end 16a and an opposite support end 16b (e.g., along an axis X-X). As illustrated by FIG. 1, the male connector 10 (e.g., such as a male fitting, or the like) comprises a male portion 12, provided at the coupling end 16a of the connector body 16. That said, it is understood that the male portion 12 may be provided on one or more ends of the connector body 16. In particular, the male portion 12 comprises a conical sealing frustum 20 with convex sides 22. In some embodiments, the male connector 10 (e.g., a male fitting) also comprises a connection portion 14, structured for operatively coupling (e.g., fastening, or otherwise securing—detachably) the male connector 10 having the male portion 12 with a compatible female connector 40 (e.g., a female fitting, or the like). FIG. 1 illustrates the male connector 10 comprising the male portion 12 and an external threaded type connection portion 14, in accordance with some embodiments of the invention. Each of these components will be described in further detail below.

As illustrated by FIG. 1, in some embodiments, the connector body 16 of the male connector 10 further comprises an end portion 15 provided at the support end 16b of the connector body 16. As such, in some embodiments the connector body 16 of the male connector 10 comprises the male portion 12, the connection portion 14, and the end portion 15, (e.g., such that the connection portion 14 is positioned between the male portion 12 and the end portion 15, with the male portion 12 forming the coupling end 16a of the connector body 16 and the end portion 15 forming the opposite support end 16b). In other embodiments, the connector body 16 of the male connector 10 comprises the male portion 12 and the connection portion 14, with the male portion 12 forming the coupling end 16a of the connector body 16 and the connection portion 14 forming the opposite support end (i.e., indicated as support end 16b′ in FIG. 1). The connector body 16 is typically structured to be operatively coupled (e.g., fixedly or detachably operatively coupled) to another external pipe, duct, or another component at the support end 16b (or 16b′ in some embodiments) (e.g., via welding, brazing, using screw-thread mechanisms, using snap/interference fits, or the like).

In some embodiments, connector body 16 is in the form of a seamless pipe having a male portion 12 and the connection portion 14 provided on the pipe (e.g., machined into the pipe, brazed, welded, fastened-screwed into, or the like). Typically, the connector body 16 comprises a hollow interior, such that transport of fluid may be facilitated from one end of the male connector 10 to the opposite end of the pipe (e.g., from the coupling end 16a to the support end 16b in a direction parallel to an axis X-X and vice versa). Typically, the connector body 16 and pipe defines a length “L” from one end to the opposite end, as illustrated (e.g., with the length L spanning the male portion 12, the connection portion 14, and the end portion 15). In the embodiments where the connector body 16 comprises the male portion 12 and the connection portion 14, with the and the connection portion 14 forming the support end 16b′, the length L may be the same as a length “F”, as illustrated in FIG. 1 (e.g., with the length F spanning the male portion 12 and the connection portion 14).

In some embodiments, the male connector 10 and/or the associated pipe is made from a carbon steel material. That said, the male connector 10 and/or the associated pipe may be made from one or more materials selected from a group comprising: metals (e.g., steel, copper, aluminum, iron, alloys thereof, etc.), concrete, cement, plastics, composites, wood, fiberglass, glass, and/or other suitable materials. In some embodiments, the male connector 10, and in particular the male portion 12, may be covered with one or more layers, such as a plating, a coating, or the like. Depending on the type of layer, the layer may be corrosion resistant, be resistant to scratches, provide a low friction surface, allow the flow of material into scratches on a surface, provide lubrication to improve seating of components, or the like. In particular, the one or more layers are structured to improve surface properties and provide enhanced sealing performance, as will be discussed in further detail herein.

As illustrated by FIG. 1, in some embodiments, the connector body 16 typically comprises a pipe structure having an axis X-X. Specifically, the connector body 16 and/or pipe comprises a cylindrical type tubular structure with an internal hollow cavity (e.g., an annular hollow cavity) defining an external diameter “D1” and an internal diameter “A” about the axis X-X. In this regard, in some instances, the connector body 16 is a pipe of nominal size ¾″ with schedule 160 (i.e., an external diameter of 1.050 inches, while the internal diameter A is 0.612 inches). In other instances, the connector body 16 and/or pipe may be of nominal size of ⅛″, ¼″, ⅜″, ½″, ¾″, 1″, 1¼″, 1½″, 2″, 2½″, 3″, 3½″, 4″, 5″, 6″, 8″, 10″, 12″, 14″, 16″-36″, or the like. That said, the connector body 16 may comprise any suitable shape with any suitable cross section(s) such as a circle, an ellipse, an oval, a curvilinear cross section, a rectangle, a polygon, another suitable shape/contour, a suitable combination of the foregoing, and/or generally or substantially any of the aforementioned shapes, with the cross section being constant or variable along the length of the connector body 16. Specifically, a cross-section of an outer surface and/or a cross-section of an inner surface (defining the interior hollow cavity) of the connector body 16 may comprise any suitable contour such as a circle, an ellipse, an oval, a curvilinear contour, a rectangle, a polygon, another suitable shape/contour, a suitable combination of the foregoing, and/or generally or substantially any of the aforementioned shapes, with the cross section being constant or variable along the length of the connector body 16.

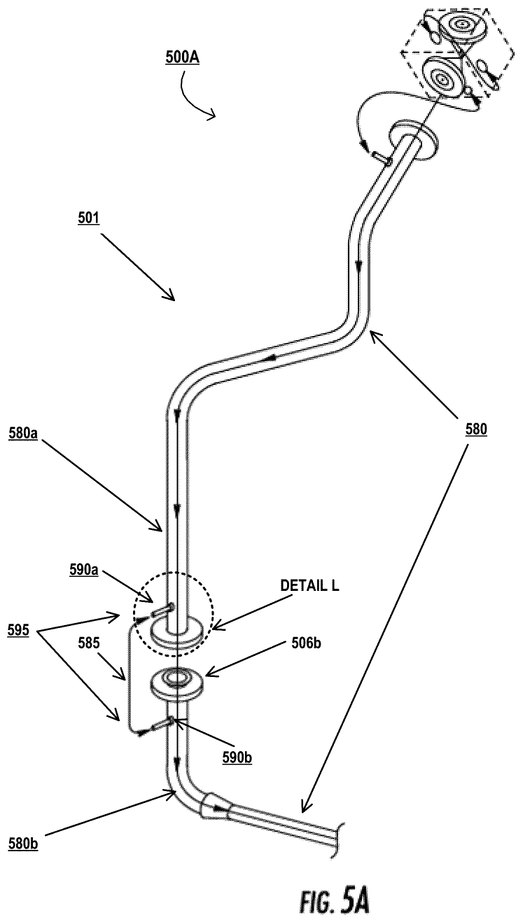

As discussed, the male connector 10 also comprises a connection portion 14, structured for operative coupling (e.g., fastening, or otherwise securing-detachably) the male connector 10 having the male portion 12 with a compatible female connector 40 having a female portion (e.g., a female flange 46 illustrated in FIG. 4). FIG. 1 illustrates, an external thread type connection portion 14 provided on the connector body 16. However, it is understood that the connection portion 14 may comprise any compatible/suitable connection means (e.g., snap-fit type, interference fit type, etc.) and may be provided at a suitable location on the male connector 10. As illustrated, the connection portion 14 comprises threads 14a (e.g., helical pipe threads, tapered threads, straight threads, etc.) and an optional shank 14b. The threads 14a may comprise a major diameter defined by the external diameter D1, and a minor diameter “D2” (e.g., a minor diameter D2 of about 0.945 inches with a tolerance of ±0.005 inches for a connector body/pipe 16 of nominal size ¾″), about the axis X-X. The threads 14a may comprise flank angles “T1” and “T2,” as illustrated. In some embodiments, the flank angle T1 may be 300 and flank angle T2 may be 45°, while in other embodiments flank angles T1 and T2 may be equal. The connection portion 14 may comprise a total length of about “F−E”, where “F” is a length spanning the male portion 12 and the connection portion 14 (e.g., a length F of about 0.864 inches with a tolerance of ±0.016 inches for a connector body/pipe 16 of nominal size ¾″) and “E” is a length of the male portion 12, as illustrated. It is noted that, in the embodiments where the shank 14b is absent, the length of the threads 14a may be about F−E. Moreover, the shank 14b may comprise a length “G” (e.g., a length G of about 0.125 inches with a tolerance of ±0.030 inches for a connector body/pipe 16 of nominal size ¾″). It is further noted that, in the embodiments where the shank 14b is present, the length of the threads 14a may be about “F−E−G”. In some embodiments, the connection portion 14 also comprises an internal hollow cavity (e.g., an annular hollow cavity contiguous with that of the end portion 15) defining the internal diameter A about the axis X-X.

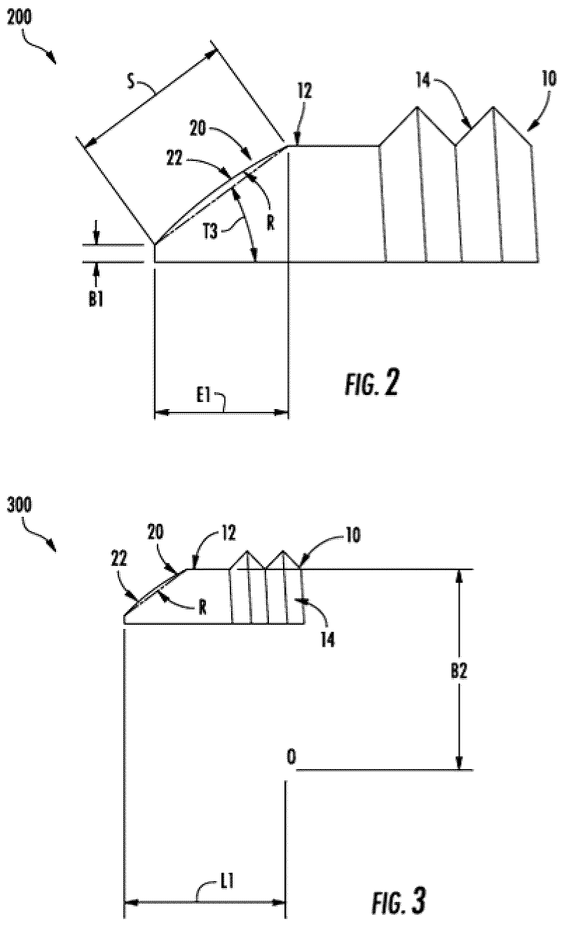

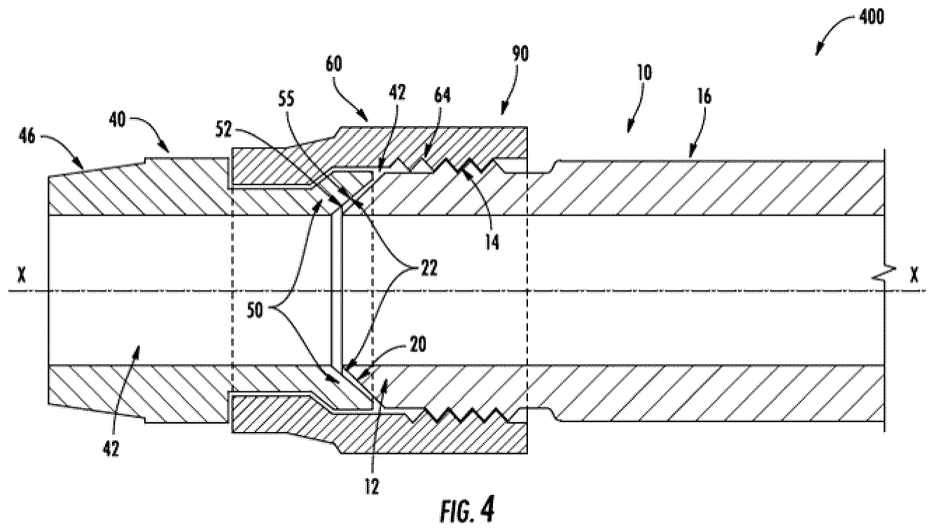

As illustrated by FIG. 1, the male portion 12 of the male connector 10 may define a length “E” (e.g., a length E of about 0.315 inches with a tolerance of ±0.016 inches for a connector body/pipe 16 of nominal size ¾″). The male portion 12 typically comprises a conical sealing frustum 20 having convex sides 22. As illustrated by FIG. 1, this conical scaling frustum 20 may begin with a maximum diameter “C” (e.g., a diameter C of about 0.938 inches with a tolerance of ±0.005 inches for a connector body 16 and/or pipe of nominal size ¾″) and taper towards a minimum diameter “B” (e.g., a diameter B of about 0.664 inches with a tolerance of ±0.003 inches for a connector body 16 and/or pipe 16 of nominal size ¾″) forming a convex curved contour therebetween. As such, in some embodiments, the diameter of the conical scaling frustum 20 may vary from diameter C to diameter B along a convex function, a quadratic function (e.g., a function of a conic section such as a circle, ellipse, parabola etc.), an exponential function, a non-linear function, and/or the like (e.g., with the diameters B and C as the limits), to form the convex curved contour therebetween. The conical sealing frustum 20 comprises convex sides 22, such that a cross-section of the conical sealing frustum 20 defines a convex curved contour along its other surface. The conical sealing frustum 20 having convex sides 22 of the male portion 12 will be described in greater detail below with respect to “Detail K” illustrated in FIG. 2 and a schematic sectional view illustrated in FIG. 3. In some embodiments, the male portion 12 also comprises an internal hollow cavity (e.g., an annular hollow portion contiguous with that of the connection portion 14 and/or the end portion 15) defining the internal diameter A about the axis X-X.

It is understood that in other embodiments the connector body 16 may have sizes other than the nominal ¾″ size (e.g., nominal size of ⅛″, ¼″, ⅜″, ½″, 1″, 1¼″, 1½″, 2″, 2½″, 3″, 3½″, 4″, 5″, 6″, 8″, 10″, 12″, 14″, 16″-36″, etc.), and as such, the dimensions of the internal diameter A, minimum diameter B, maximum diameter C, external diameter D1, minor diameter D2, length of the male portion E, length F, and length G, may vary proportionally with the corresponding nominal size of the pipe.

FIG. 2 illustrates a detailed sectional view 200 (Detail K) of the male connector 10 of FIG. 1, in accordance with some embodiments of the invention. FIG. 3 also illustrates a detailed sectional view 300 of the male connector 10 of FIG. 1, in accordance with some embodiments of the invention.

Referring to FIG. 2, as discussed, the male portion 12 comprises a conical scaling frustum 20 having convex sides 22, such that the conical sealing frustum 20 may define a maximum diameter C (illustrated in FIG. 1) and a minimum diameter B (illustrated in FIG. 1), forming convex sides 22 therebetween along an convex axial length “E1” (e.g., a convex axial length E1 of about 0.188 inches for a connector body/pipe 16 of nominal size ¾″). The conical sealing frustum 20 comprises convex sides 22, such that a cross-section of the conical sealing frustum 20 defines a convex curved contour along its taper on the outer surface. The conical scaling frustum 20 may generally taper along a slope angle “T3” (e.g., a slope angle T3 of 36.1°) with a slope length “S” (e.g., a slope length S of about 0.233 inches for a connector body 16 and/or pipe 16 of nominal size¾″) along a slope line (illustrated in dashed lines). The end of the male connector 10 proximate to the male portion 12 may define a thickness “B1” (e.g., a thickness B1 of about 0.026 inches for a connector body 16 and/or pipe of nominal size ¾″). In other words, the thickness B1 is a difference between the minimum diameter B and the internal diameter A (illustrated in FIG. 1). Thickness B1 may be zero in some embodiments, which is not illustrated in the figures.

As discussed, the convex sides 22 of the conical sealing frustum 20 define a convex curved contour along its taper on the other surface. In some embodiments, the diameter of the conical sealing frustum 20 may vary from diameter C to diameter B along a quadratic function of a section of a circle to form the convex curved contour therebetween. Here, the convex contour of the convex sides 22 comprises a convex radius “R” (e.g., a convex radius R of about 0.672 inches for a connector body 16 and/or pipe of nominal size ¾″). Now referring to FIG. 3, the convex radius R is defined about a center “O”. This center O may be offset from the axis X-X and may be located at a perpendicular distance of “L1” from free end of the conical scaling frustum 20 and at a perpendicular distance of “B2” from the maximum diameter C of the conical sealing frustum 20, as illustrated by FIG. 3. For instance, for a connector body 16 whose pipe is of a nominal size of ¾″ size, the distance L1 may be about 0.484 inches and the distance B2 may be about 0.603 inches.

It is noted that in other embodiments not illustrated herein, the diameter of the conical sealing frustum 20 may vary from diameter C to diameter B along a quadratic function of a section of a parabola, an ellipse, or the like to form the convex curved contour therebetween. Here, “R” may be a function defining the distance between the convex contour of the convex sides 22 and a focus “O”.

It is understood that in other embodiments the connector body 16 and/or pipe may have a nominal size other than the ¾″ size generally described herein (e.g., nominal size of ⅛″, ¼″, ⅜″, ½″, 1″, 1¼″, 1½″, 2″, 2½″, 3″, 3½″, 4″, 5″, 6″, 8″, 10″, 12″, 14″, 16″-36″, etc.), such that the dimensions of convex axial length E1, slope length S, thickness B1, convex radius R, distance L1, and distance B2, may vary proportionally with the corresponding nominal size of the pipe.

FIG. 4 illustrates a cross-sectional view 400 of a connector assembly 90, in accordance with some embodiments of the invention. Specifically, FIG. 4 illustrates, the connector assembly 90, which comprises the male connector 10 (described with respect to FIGS. 1-3) being operatively coupled to a compatible female connector 40 to form a line-seal. As discussed previously with respect to FIGS. 1-3, the male connector 10 comprises a male portion 12 and a connection portion 14. The male portion 12 comprises a conical scaling frustum 20 having convex sides 22. The convex sides comprise a tapered curvature, as described with respect to FIGS. 2-3.

Referring to FIG. 4, in some embodiments, the female connector 40 (e.g., female fitting, or the like) comprises a female flange 46 and a female nut 60, which may be operatively coupled to each other (e.g., integrally, detachably, separate but coupled, or the like as will be described herein). In some embodiments, the female flange 46 and the female nut 60 are separate components that are structured to be detachably coupled to each other, while in other embodiments, the female flange 46 and the female nut 60 are integral portions of the female connector 40. Typically, the female connector 40, in particular the female flange 46 and the female nut 60, are tubular having an opening or internal hollow portion 42, and are symmetrical about the axis X-X. Like the male connector 10, the female connector 40 may be operatively coupled to a pipe (e.g., integral with a pipe, brazed, welded, fastened to-screwed, or the like). Typically, the internal hollow portion 42 is structured to facilitate transfer of fluids from one end of the female connector 40 to another opposite end, in the direction of or along the axis X-X. In some embodiments, the internal hollow portion 42 of the female connector 40 is contiguous with the internal hollow portion of the male connector 10, and the female connector 40 and the male connector 10 are coaxial when the male connector 10 is operatively coupled to the female connector 40. In this way, fluids may be transferred from an end region of the male connector 10 (e.g., from support end 16b via the coupling end 16a) to an end region of the female connector 40, in the direction of or along the axis X-X, or vice versa.

The female connector 40 typically comprises the opening or internal hollow portion 42 (e.g., an annular recess/hollow 42) that is structured to receive or otherwise accommodate at least a portion of the male connector 10 (e.g., male portion 12). This internal hollow portion 42 may be provided by the at least a portion of the female flange 46 and/or at least a portion of the female nut 60. As illustrated in FIG. 4, in some embodiments, the female connector 40 is structured to receive and/or surround the male portion 12 and/or at least a portion of the connection portion 14 of the male connector 10 within the internal hollow portion 42, when the male connector 10 is operatively coupled to the female connector 40. Here, the male connection portion 14 of the male connector 10 may be operatively coupled (e.g., detachably secured, or the like) to a compatible or complementary female connection portion 64 of the female nut 60 of the female connector 40 for the coupling of the male connector 10 with the female connector 40. In the embodiment illustrated in FIG. 4, the female connection portion 64 comprises complementary internal threads provided on the interior surface defining the internal hollow portion 42 of the female nut 60 that are configured to operatively coupled (e.g., assemble and detach) with the threads of the connection portion 14 of the male connector 10.

Furthermore, the female flange 46 of the female connector 40 may further comprise a seat portion 50, such as a seat having slanted surfaces 52 as illustrated by FIG. 4. In typical connectors, the slanted surfaces of male fittings and female fittings are straight with negligible or no curvature in the cross section, and are typically structured to form surface to surface contact, and thus, a surface to surface seal (e.g., a straight male surface with another corresponding straight female surface). However, the male connector 10 of the present disclosure is structured such that, the convex sides 22 of the conical sealing frustum 20 of the male connector 10 forms a line contact 55 with the slanted surfaces 52 of the female connector 40, when the male connector 10 is operatively coupled to the female connector 40. This line contact 55 may take the form of a circumferential line contact or a narrow ring of contact (e.g., a circle 55 about the central axis X-X in a plane perpendicular to the central axis X-X). Alternatively, it should also be understood that the convex sides 22 of the conical sealing frustum 20 of the male connector 10 allows for slight angular misalignment with the female connector 40 (e.g., the male connector 10 and the female connector 40 may be slightly off angle) and the line contact 55 is still formed between convex sides 22 and the slanted surfaces 52. In this way, the connector assembly 90 of the male connector 10 and the female connector 40 forms a line-seal 55 for transfer of fluids therebetween. Moreover, the male connector 10 of the present invention may be assembled with any existing compatible female connector 40 to form the line-seal 55, even though the female connector 40 may be conventionally structured for a surface to surface seal, and hence obviates the need to replace existing surface-contact type female connectors in order to form the line seal.

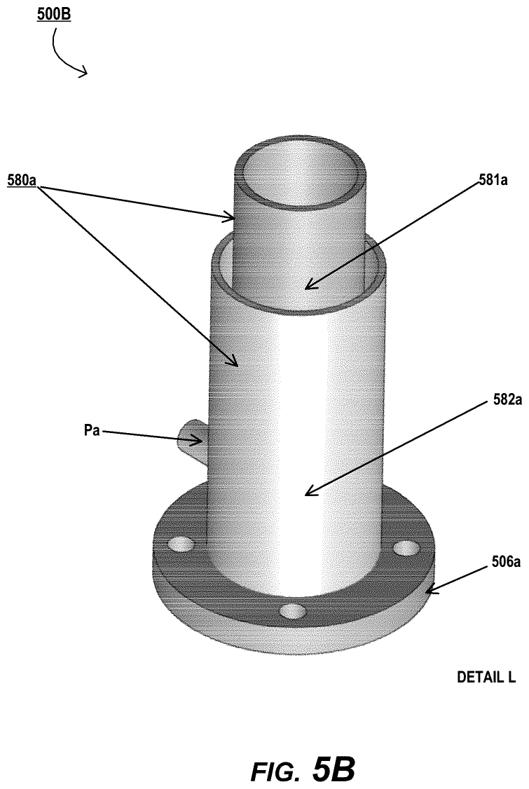

In this way, the male connector 10 provides effective line-scaling for transport of fluids, and is compatible with the sealing requirements of a wide variety of fluids such as steam, hot glycol and water-glycol mixture in particular, in a variety of applications (e.g., tracer pipes associated with liquid sulfur or hydrogen sulfide gas transport, jacketed pipes, high-performance—such as high-pressure, high-flow, high-temperature or hazardous-material, jacketed flanges, conveyance of fluids, or the like). Not only does the present invention provide effective line-scaling as discussed above, the connector assembly 90, and more particularly, the male connector 10 of the present invention is also structured to increase a seating pressure of the seal, decrease seating torque required for forming the seal, and improve the sealing performance. For example, in some embodiments, depending on the fluid being used, the size of the pipes, the pressures and/or temperatures of the systems, or the like, the connector assembly 90 of the present disclosure improves the operating pressure resistance compared to traditional surface to surface sealing connectors by 10, 20, 30, 40, 50, 60, 70, 80, 90, 100, 200, or the like percent (or any range of percentages that falling within, outside overlapping any of these values). For example, in some embodiments, depending on the fluid being used, the size of the pipes, the pressures and/or temperatures of the systems, or the like, the connector assembly 90 of the present disclosure decreases the seating torque required for establishing the line-seal, in comparison with traditional straight fitting (e.g., having a straight frustum male connector) by 10, 20, 30, 40, 50, 60, 70, 80, 90, 100, or the like percent (or any range of percentages that fall within, outside, or overlap any of these values). In this regard, non-limiting test results depicting improvements to seating torque requirements for establishing sealing provided by the convex male connector of the present invention are illustrated and described with respect to FIG. 10 in further detail below. Moreover, some non-limiting applications of the connector assembly 90 will be described with respect to FIGS. 5A-9 in further detail below.

As a non-limiting example, it is envisaged that, in some applications, the line-seal 50 may presumably deteriorate due to wear and tear during use of the connector assembly 90, during manufacturing, packaging, shipping, assembly, or the like utilization that could potentially cause surface flaws in the connector assembly 90 (e.g., male connector 10 and/or female connector 40). For instance, a scratch across the slanted surfaces 52 and/or the conical sealing frustum 20 may cause a break/by-pass in the line-seal 55. In order to preclude such a scenario, as yet another improvement provided by the invention, the male connector 10 and particularly, the convex sides 22 of the conical sealing frustum 20 of the male portion 12 may comprise one or more layers, as previously discussed herein. In some embodiments the one or more layers may comprise a plating. The plating may comprise a hard metal (e.g., harder than a coating), such as a chrome, zinc, alloy, or other plating. In general, a plating may increase the hardness of the underling material (e.g., the connector material), which may make the surface more resistant to scratches. Additionally, the plating may provide corrosion protection of the underlying surface. Moreover, the plating may also provide a low-friction surface to aid in seating the connector(s) (e.g., the male connector 10 and the female connector 40, or the like).

In some embodiments, the one or more layers may comprise a coating. The coating may be a soft material (e.g., softer than a plating), such as Teflon, paint, grease, film, or the like coating. In general, a coating may include the ability to at least partially (or completely) flow into and/or fill any scratches within the connector(s) (e.g., the male connector 10 and the female connector 40, or the like), and allow for improved sealing in the event a scratch is located within the connector(s). Furthermore, the coating may also provide corrosion protection. Moreover, the coating may also provide lubrication to aid in improving the seating of the connector(s) (e.g., the male connector 10 and the female connector 40, or the like). In some embodiments the coating may comprise a fluorocarbon coating, such as Polytetrafluoroethylene (PTFE) or Teflon™ (not illustrated in the figures). The fluorocarbon coating is structured such that (i) the fluorocarbon coating comprises high surface hardness to prevent deterioration, and (ii) the fluorocarbon coating comprises a trace amount of compressibility (typically greater than that of the material of the male connector 10) that would allow the coating to deform when the line-seal is formed, thereby allowing compensation or rectification of any scratches/surface abrasions. It should be understood with respect to the coatings, the flow of material or particles of the coating may facilitate decrease/removal of any scratches/surface abrasions.

It should be understood that the one or more layers, such as the coating, plating, or the like, may be structured to provide a gasket-like sealing property. It should be understood, that with or without the use of the one or more layers (e.g., plating, coatings, or the like), the shape of the fittings, in particular the male connector 10, as described herein provides for improved sealing (e.g., at lower torque values), and thus the fluid sealing can be formed as needed without the use of a gasket.

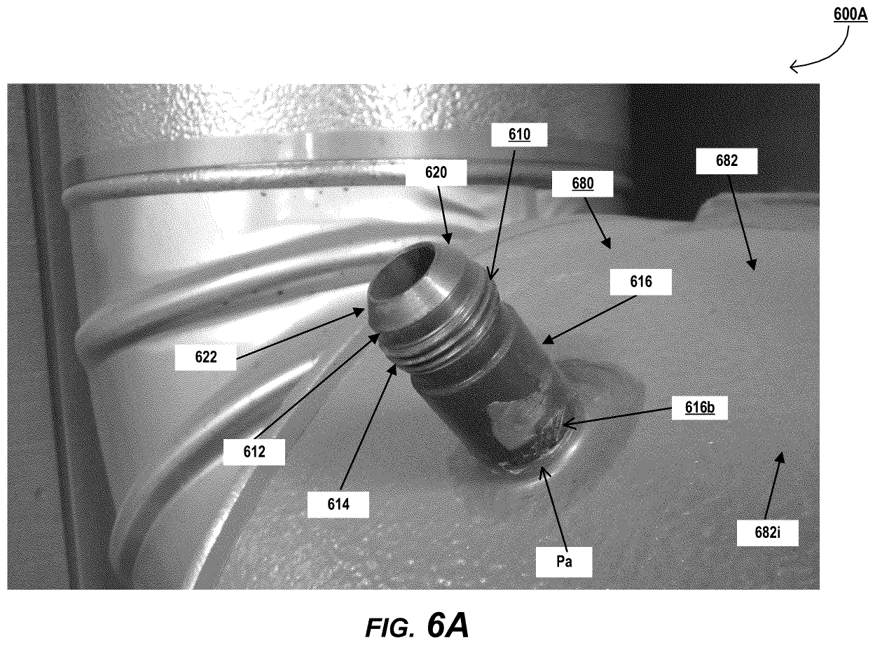

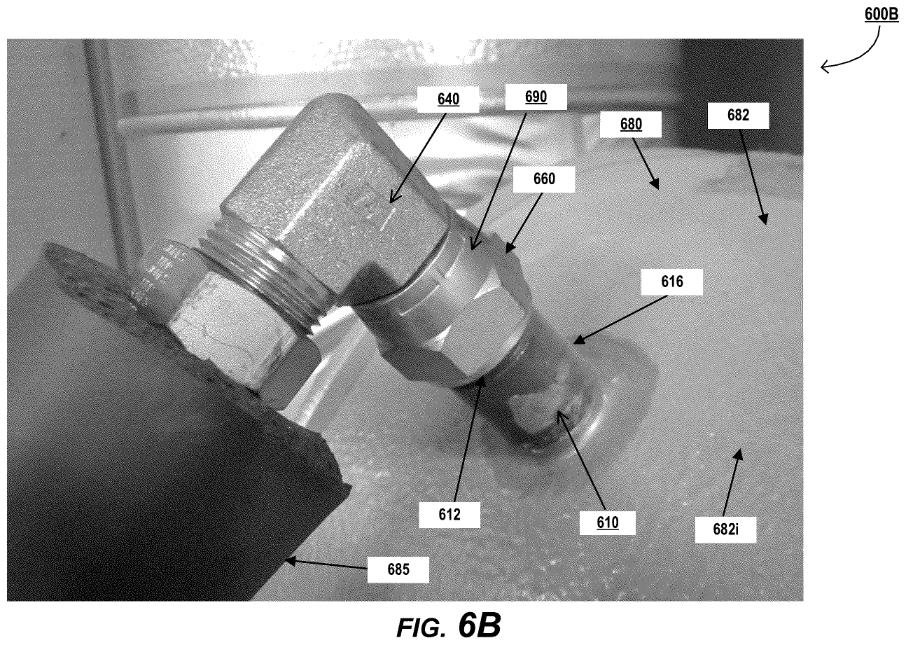

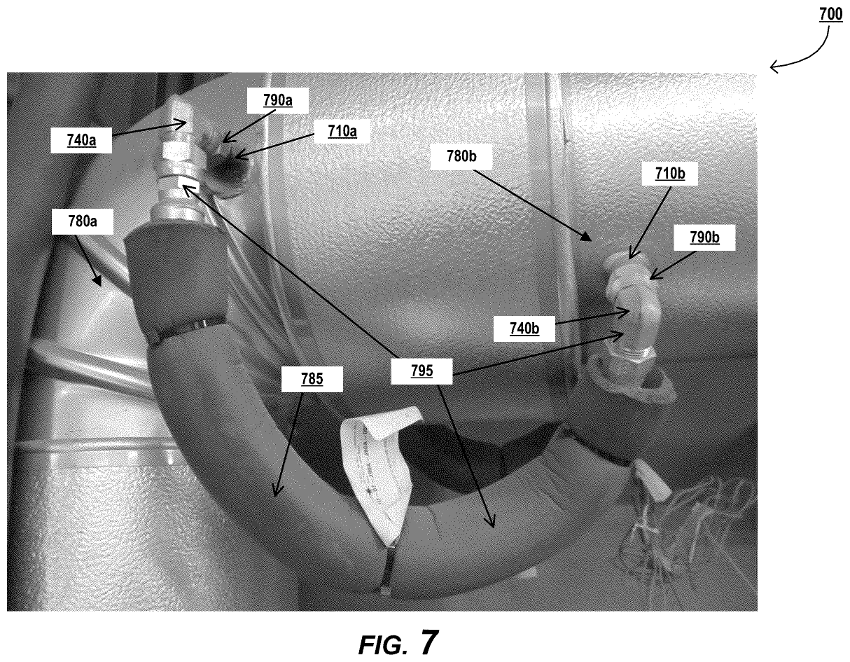

The steps of forming and/or assembling the connector assembly 90 will now be described in further detail. Initially, the male connector 10 is constructed and/or manufactured according to the features and functions described above. The connector body 16 of the male connector 10 may be operatively coupled (e.g., affixed to or integral with) a pipe or other conduit (e.g., illustrated at FIGS. 5A-8C). The female flange 46 and the female nut 60 of the female connector 40 as described above are also provided. Also, optionally, an end portion of the female flange 46 (e.g., an end away from the seat portion 50) of the female connector 40 may be operatively coupled to a second pipe or other conduit (e.g., illustrated at FIGS. 6b-7). Next, the female nut 60 may be operatively coupled (e.g., snap-fit onto, rotatably connected during manufacturing, or otherwise coupled with) the female flange 46, when the female flange 46 and the female nut 60 are provided separately. Next, the male portion 12 of the male connector 10 is inserted within the internal hollow portion 46 of the female connector 40. Next, the connection portion 14 of the male connector 10 may be operatively coupled (e.g., detachably secured, or the like) to the compatible/complementary female connection portion 64 of the female connector 40. In this regard, in the instances where the connection portions (14, 64) form a pair of compatible/complementary threads as illustrated by FIG. 4, the female nut 60 (coupled to the female flange 46) may be rotated about the male connector 10 and about the female flange 46, thereby causing the progressive engagement of the threads, and consequently causing the female flange 46 and the male portion 12 of the male connector 10 to move towards one another in an axial direction, until the convex sides 22 of the conical sealing frustum 20 and the slanted surfaces 52 of the female connector 40 establish a line contact seal 55 there between. It is noted that, for disassembly, the foregoing steps may be performed in a reverse order.

FIG. 5A illustrates a perspective view 500A of a process system 501 having one or more jacketed pipes 580 and incorporating a plurality of connector assemblies (590a, 590b). Specifically, the process system 501 is associated with transport of a process fluid (also referred to as a transport fluid) such as liquid sulfur or hydrogen sulfide, a high-pressure fluid, a high-flow fluid, a high-temperature fluid, or the like. As discussed, the process system 501 may comprise a network of process pipe(s) 580 (also referred to as main pipes) in the form of jacketed pipes (580a, 580b) that are structured to transport/convey the transport fluid. The structure of the jacketed pipes will be described with respect to Detail L illustrated in FIG. 5B.

FIG. 5B illustrates a schematic sectional view 500B of a jacketed pipe at Detail L of FIG. 5A. The jacketed pipe 580a typically comprises a core pipe 581a (also referred to as a carrier pipe, a center pipe, a first pipe) and an outer pipe 582a (also referred to a second pipe, or the like) at least partially surrounding (e.g., completely surrounding, or the like) the core pipe 581a, such that an annular hollow portion is formed there between. In some embodiments, the outer pipe 582a may comprise a flange 506a on one end or both ends. The process fluid (also referred to as a transport fluid) such as liquid sulfur or hydrogen sulfide, a high-pressure fluid, a high-flow fluid, a high-temperature fluid, etc., may be transported through the core pipe 581a. In order to maintain predetermined properties of the process fluid during transport, e.g., to maintain the process fluid at a predetermined temperature (e.g., at or above a melting point of the process fluid, above a crystallization temperature, at a desired temperature for a liquid or gaseous state, or the like), a jacket fluid is conveyed in the annular hollow portion between the core pipe 581a and the outer pipe 582a. Here, jacket fluid is a suitable fluid such as steam, hot oil, water, glycol, water glycol mixture, etc., therein having fluid properties and operating characteristics such that the jacket fluid in the annular hollow portion is configured to maintain predetermined properties of the process fluid during transport in the core pipe 581a. Moreover, the outer pipe 582a may comprise a pipe connection Pa. The components, features, structure and function of the jacketed pipe 580b (and any other jacketed pipes of the process system 501) may be substantially similar to the jacketed pipe 580a described above. As such, the jacketed pipe 580b may comprise a core pipe 581b and an outer pipe 582b (e.g., having a pipe connection Pb) and a flange 506b.

Now referring to FIG. 5A, because it may not be possible to manufacture contiguous jacketed pipes along the entire length of the process system 501, multiple jacketed pipes (580a, 580b) may need to be joined to cover the length of the process system 501. Here, the jacketed pipe assembles 580a and 580b may need to be joined via a flange-to-flange connection formed by flanges (506a, 506b). However, the flanges (506a, 506b) at proximate ends of the pair of jacketed pipes (580a, 580b) may not be optimal for or may impede flow of jacket fluid between the jacketed pipes (580a, 580b). To solve this problem, a connection system 595 comprising one or more connector assemblies (590a, 590b) along with one or more bridge pipes 585 (also referred to as a hose pipe) may be provided at pipe connection locations (Pa, Pb) to establish operative fluidic connection and sealing between the outer pipes 582a and 582b of the jacketed pipes (580a, 580b) to allow flow of jacket fluid between the jacketed pipes (580a, 580b). These connector assemblies (590a, 590b) may be substantially similar to the connector assemblies (90, 690, 790a-790b) of FIGS. 4, 6B and 7 respectively, and the connection system 595 may be substantially similar to the connection system 795 of FIG. 7, as described in detail below.

FIG. 6A illustrates a perspective view 600A of a male connector 610 installed at a jacketed pipe 680, in accordance with some embodiments of the invention. In particular, FIG. 6A illustrates the male connector 610, substantially similar to the male connector 10 described previously with respect to FIGS. 1-4, being assembled to an outer pipe 682 of a jacketed pipe 680 at a pipe connection location Pa (substantially similar to the jacketed pipes (580a, 580b) described above). As discussed, the outer pipe 682 may be a vessel that covers a core pipe 681 (not illustrated) similar to core pipes (581a, 581b) associated with liquid sulfur or hydrogen sulfide gas transport, a high-performance (e.g., high-pressure, high-flow, high-temperature or hazardous-material) pipe, a pipe structured for facilitating or monitoring flow of fluids such as steam, hot glycol and water-glycol mixture, or another fluid/suspension/mixture, or the like. As illustrated by FIG. 6A, the connector body 616 of the male connector 610 may be operatively coupled (e.g., affixed permanently by welding, or the like) to the jacketed pipe 680 at the support end 616b of the connector body 616, opposite the male portion 612 having conical sealing frustum 620 having convex sides 622. As discussed previously, the male connector 610 also comprises a connection portion 614. Moreover, the jacketed pipe 680 may be covered by insulation exposing the male connector 610.

FIG. 6B illustrates a perspective view 600B of a connector assembly 690 installed at a jacketed pipe of FIG. 6A, in accordance with some embodiments of the invention. In particular, FIG. 6 illustrates the male connector 610, as described previously with respect to FIG. 6A, being assembled to a corresponding female connector 640, substantially similar to the female connector 40 described with respect to FIG. 4, to form the connector assembly 690. The female connector 640 is operatively coupled (e.g., affixed permanently, detachably, or the like) to a bridge pipe 685 (or another pipe) at an end opposite the female nut 660. The pipe 685 may be a flexible hose (e.g., metal sheathed, or the like). FIG. 6B illustrates the male connector 610 being operatively coupled to (e.g., assembled with) the female connector 640 to form a line-seal therebetween (not illustrated) via the male portion 612 of the male connector 610. It should be understood that the jacketed pipe 680, may utilize the connector assembly 690 along with the bridge pipe 685, e.g., to jump over pipe flanges, to provide or receive fluid that heats or cools process fluid located within the process pipe around which the jacketed pipe is in covering relation, as discussed previously with respect to FIGS. 5A-5B and below with respect to FIG. 7. As such, the outer pipe 682 indicated by FIGS. 6A and 6B typically may be an insulated pipe surrounded by insulation 682i (such as aluminum cladding) forming the outer surface in some embodiments.

FIG. 7 illustrates a perspective view 700 of a connection system 795, in accordance with some embodiments of the invention. Specifically, FIG. 7 illustrates a perspective view 700 of a jacketed pipe 780 having an outer pipe 782 provided around a core pipe 781 (not illustrated) (substantially similar to the jacketed pipes (580a, 580b, 680) described above) having the connection system 795, in accordance with some embodiments of the invention. Similar to FIGS. 6A-6B, FIG. 7 illustrates a first male connector 710a (substantially similar to the male connector 10 described previously with respect to FIGS. 1-4 and/or male connector 610 of FIGS. 6A-6B) being assembled to a first jacketed pipe 780a (covered in insulation), substantially similar to the pipes (580a, 580b and 680) described above, at a first location. FIG. 7 further illustrates a second male connector 710b (substantially similar to the male connector 10 described previously with respect to FIGS. 1-4 and/or male connector 610 of FIGS. 6A-6B) being assembled to a second jacketed pipe 780b at a second location away from the first location. It should be understood that the first jacketed pipe 780a and the second jacketed pipe 780b meet at a flange-to-flange connection (not illustrated) due to the covering insulation.

Similar to FIGS. 4 and 6A-6B, FIG. 7 illustrates each male connector (710a, 710b) being assembled to a corresponding female connector (740a, 740b), to form a first connector assembly 790a and a second connector assembly 790b, respectively. Moreover, the female connectors (740a, 740b) each, in turn, are connected/affixed to opposite ends of a bridge pipe 785, as illustrated by FIG. 7. Accordingly, the bridge pipe 785 has a first female connector 740a on one end, and a second female connector 740b on the opposite end. The female connectors (740a, 740b) are substantially similar to the female connectors 40 and 640 described previously. Furthermore, FIG. 7 illustrates the male connector 710a being operatively coupled to/assembled with the female connector 740a to form a line-seal therebetween (not illustrated), and the male connector 710b being operatively coupled to/assembled with the female connector 740b to form a line-seal therebetween (not illustrated) in order to use the bridge pipe 785 to allow fluid to flow from the first jacketed pipe 780a to the second jacketed pipe 780b. As such, the male connectors (710a, 710b) and the bridge pipe 785 are used to jump the flange-to-flange connection (not illustrated) between the first jacked pipe 780a and the second jacketed pipe 780b in order to maintain the flow of fluid therebetween.

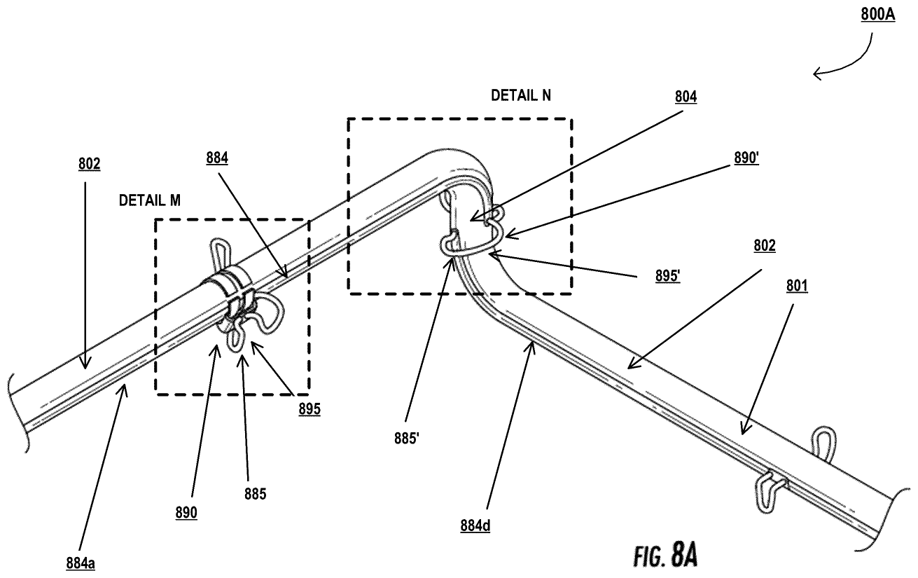

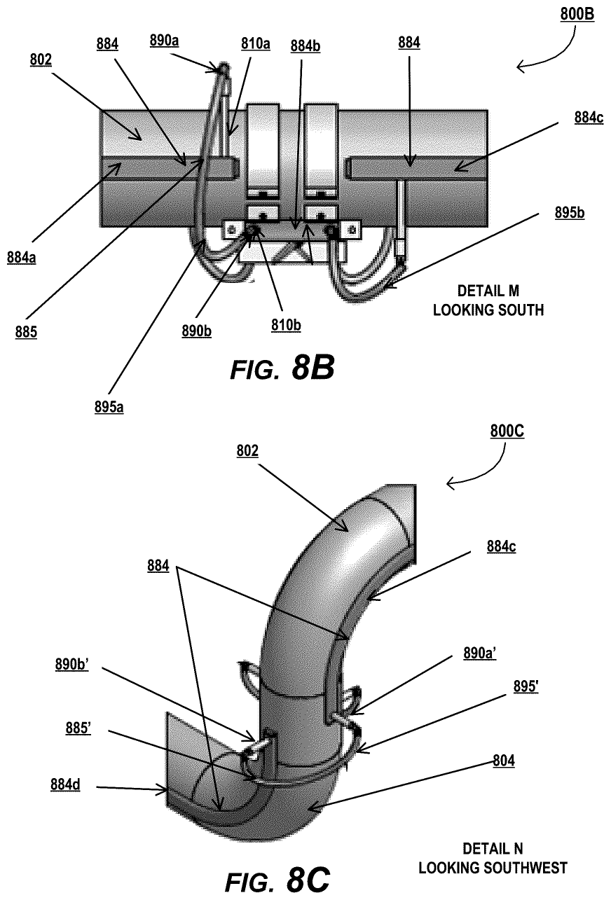

FIGS. 8A-8C illustrate perspective views 800A-800C of a tracer piping system 801, in accordance with some embodiments of the invention. Specifically, FIG. 8A illustrates a perspective view 800A of a tracer piping system 801, such an application associated with transport of a process fluid such as liquid sulfur or hydrogen sulfide, a high-pressure fluid, a high-flow fluid, a high-temperature fluid, etc. Typically, the tracer piping system 801 comprises a network of main pipe(s) (e.g., process pipes) 802 that are structured to transport/convey the process fluid. The tracer piping system 801 may further comprise a tracer pipe assembly 884 for heating the process fluid within the main pipe(s) 802. In this regard, the tracer pipe assembly 884 facilitates flow of a tracer fluid such as steam, hot oil, water, glycol, water glycol mixture, or the like therein, e.g., for heating the process fluid within the main pipe(s) 802. However, it may not be possible to manufacture contiguous tracer pipes along the entire length of the main pipes(s) 802. Here, sections of the tracer pipes (e.g., 884a, 884d, etc.) may need to be joined to cover the length of the main pipe(s) 802. Moreover, in some instances, e.g., at a bend 804 of the main pipe(s) 802, it may be optimal to place sections of tracer pipes radially distant on the circumference of the bend 804 to obtain optimal heating of the process fluid within the main pipe(s) 802. In this regard, connector assemblies (890, 890′) together with tracer bridge pipes (885, 885′) (also referred to as tracer hose pipes) are used to form connection systems (895, 895′) which are employed to establish operative fluidic connection and sealing between the sections of the tracer pipes (e.g., 884a, 884d, etc.). As non-limiting examples, the tracer bridge pipe 885 with connector assemblies 890 illustrated at “Detail M” at FIG. 8B, the tracer bridge pipe 885′ with connector assemblies 890′ illustrated at “Detail N” at FIG. 8C, or the like, may be utilized to establish operative fluidic connection and sealing between the sections of the tracer pipes (e.g., 884a, 884d, etc.). These tracer bridge pipes (895, 895′) may be substantially similar to the bridge pipes 585-785 described previously.

FIG. 8B illustrates a perspective view 800B of Detail M of FIG. 8A. Specifically, FIG. 8B illustrates a portion of a tracer pipe assembly 884 having a plurality of tracer pipes (884a, 884b, 884c), which are operatively connected by a plurality of connection systems (895a, 895b). Specifically, connection system 895 comprises two male connectors 810a and 810b (substantially similar to the male connectors 10, 610, 710a-710b, described previously) being operatively coupled to corresponding female connectors (not illustrated) to form respective connector assemblies (890a, 890b). The connector assemblies (890a, 890b) are operatively coupled via a tracer bridge pipe 885, forming a connection system 895a, for establishing operative fluidic connection and sealing between the sections of the tracer pipes (884a, 884b), in a manner similar to that described with respect to the jacketed pipe assemblies of FIGS. 5A-7. In a similar manner, operative fluidic connection and sealing between the sections of the tracer pipes (884b, 884c) may be established via connection system 895b.

FIG. 8C illustrates a perspective view 800C of Detail N of FIG. 8A. Specifically, FIG. 8C illustrates a connection system 895′ comprising two connector assemblies (890a′, 890b′) together with a tracer bridge pipe 885′ for establishing operative fluidic connection and sealing between the sections of the tracer pipes (884c, 884d) around the bend the bend 804 of the main pipe 802, in a manner similar to that described with respect to the jacketed pipe assemblies of FIGS. 5A-7 and tracer pipe tracer pipe assembly of FIG. 8B.

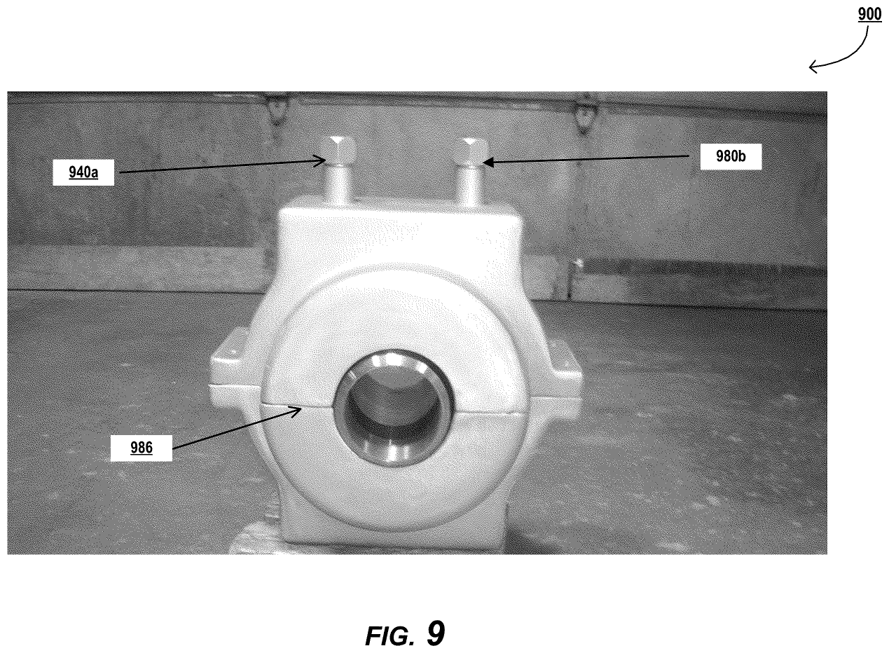

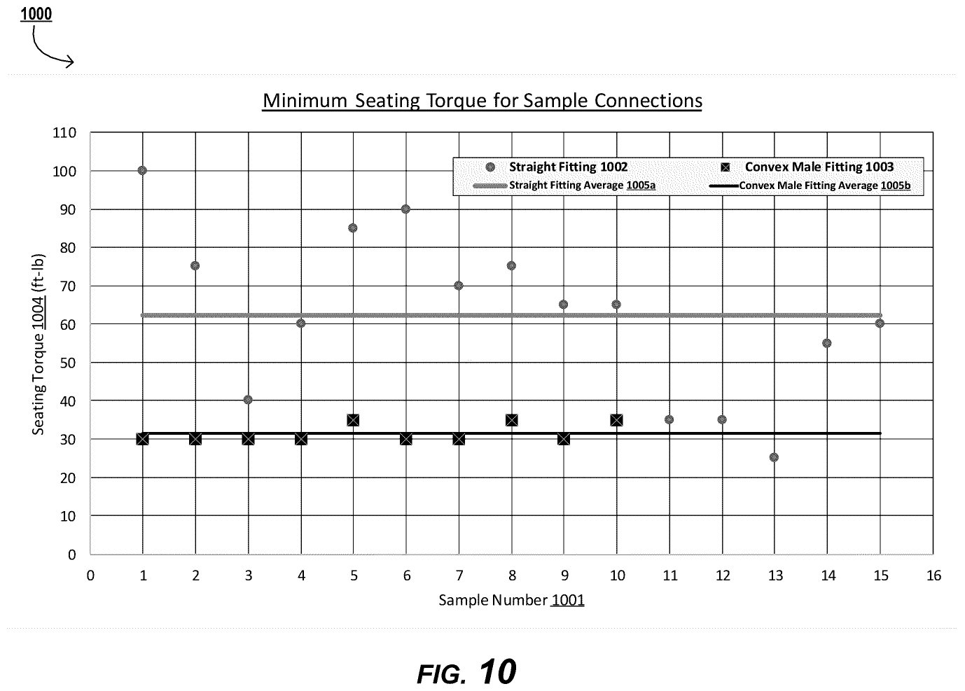

FIG. 9 illustrates a perspective view of a valve heating jacket system 900, in accordance with some embodiments of the invention. Specifically, FIG. 9 illustrates a perspective view of a heat jacket 986 positioned at or bolted onto a valve (or another component) to provide heat. The heating fluid (e.g., tracer fluid or jacket fluid) typically flows through a chamber in the casing of the heat jacket 986. The casing is structured to conduct heat from the chamber to the valve. Moreover, the casing of the heat jacket 986 may comprise one or more female connectors (940a, 940b) for facilitating flow of heating fluid into and/or away from the heat jacket 986. The female connectors (940a, 940b) are structured to be coupled to corresponding male connectors (910a, 910b) (not illustrated) of a bridge pipe that arc substantially similar to male connectors 10, 610, 710a-710b, described previously. Alternatively, one or more male connectors may be operatively coupled to the heat jacket 986 and the one or more female connectors may be operatively coupled to the bridge pipe. In still other embodiments the heat jacket 986 may have at least one male connector and at least one female connector, while the bridge pipe may have at least one male connector and at least one female connector.

FIG. 10 illustrates a plot 1000 associated with non-limiting test results depicting improvements to seating torque requirements for establishing sealing, in accordance with some embodiments of the invention. As discussed previously, the connector assembly 90, and more particularly, the male connector 10 of the present invention, provides effective line-scaling for transport of fluids, and is compatible with the sealing requirements of a wide variety of fluids such as steam, hot glycol and water-glycol mixture in particular, in a variety of applications (e.g., tracer pipes associated with liquid sulfur or hydrogen sulfide gas transport, jacketed pipes, high-performance—such as high-pressure, high-flow, high-temperature or hazardous-material, jacketed flanges, conveyance of fluids, or the like). Not only does the present invention provide effective line-scaling, the connector assembly 90, and more particularly, the male connector 10 of the present invention is also structured to decrease the seating pressure required for establishing the seal, as described herein.

Testing was conducted to determine the performance and characteristics of the connector assembly 90, and more particularly, the convex male connector 10 of the present invention in comparison with conventional straight fittings having a straight frustum male connector (not illustrated). Identical tests were conducted on samples of both the conventional straight fittings and the male connector 10 of the present invention. For the conventional straight fittings, the test method involved, for each sample, placing the straight frustum male connector within a hollow portion of a corresponding female connector, applying seating torque to couple the two and gradually increasing the seating torque applied to a nut of the female connector until a seal was accomplished between the male and female components. The minimum seating torque 1004 that was required for establishing the seal was tabulated for each sample of the conventional straight fitting 1002, as indicated by Table 1 below. Similarly, for the convex male connector 10 of the present invention, the test method involved, for each sample, placing the convex male connector 10 within a hollow portion of a corresponding female connector 40, applying seating torque to couple the two and gradually increasing the seating torque applied to a female nut 60 of the female connector 40 until a seal (i.e., line seal) was accomplished between the male and female connectors (10, 40). The minimum seating torque 1004 that was required for establishing the seal was tabulated for each sample of the convex male connector 1003, as indicated by Table 1 below. The plots of these measured minimum seating torques 1004 for establishing seals for each sample of both the conventional straight fitting 1002 and the convex male connector 1003 of the present invention are illustrated by FIG. 10.

TABLE 1
Minimum Seating Torque for Sample Connections

| | Sample | Straight | Convex Male |
|---|---|---|---|
| | No. 1001 | Fitting 1002 | Fitting 1003 |
| Minimum | 1 | 100 | 30 |
| Seating Torque | 2 | 75 | 30 |
| Required for | 3 | 40 | 30 |
| Seal (ft-lb) | 4 | 60 | 30 |
| 1004: | 5 | 85 | 35 |
| | 6 | 90 | 30 |
| | 7 | 70 | 30 |
| | 8 | 75 | 35 |
| | 9 | 65 | 30 |
| | 10 | 65 | 35 |
| | 11 | 35 | |
| | 12 | 35 | |
| | 13 | 25 | |
| | 14 | 55 | |
| | 15 | 60 | |
| Average | | 62.3 | 31.5 |
| Seating Torque | | | |
| (ft-lb) 1005: | | | |
| Standard | | 21.6 | 2.4 |
| Deviation 1006: | | | |
| Percentage | | 100% | 51% |
| of Original | | | |
| Average Torque | | | |
| 1007: | | | |

As indicated by both Table 1 and FIG. 10, the minimum seating torque 1004 required for establishing sealing is significantly reduced for the convex male connector 1003 of the present invention in comparison with that required for the conventional straight fitting 1002. Indeed, the average 1005b of the minimum seating torques required for the samples of the convex male connector 1003 was determined to be about 31.5 ft-lb, which is only about 51% of the average 1005a seating torque of about 62.3 ft-lb required for the samples of the conventional straight fitting 1002 (i.e., a 49% reduction). These values are indicated at 1005 and 1007 at Table 1 and average plots (1005a, 1005b) of FIG. 10. Moreover, the standard deviation 1006 of the measured minimum seating torque requirements 1004 across the samples of the convex male connector 1003 was determined to be about 2.4, which is a drastic improvement over the very high standard deviation 1006 of about 21.6 obtained across the samples of the conventional straight fitting 1002.

That said, it is understood that in some embodiments, depending on the fluid being used, the size of the pipes, the pressures and/or temperatures of the systems, or the like, the connector assembly 90 of the present disclosure decreases the seating torque required for establishing the line-seal, in comparison with traditional straight fitting (e.g., having a straight frustum male connector) by 10, 20, 30, 40, 50, 60, 70, 80, 90, 100, or the like percent (or any range of percentages that falling within, outside overlapping any of these values). Moreover, it is understood that in some embodiments, depending on the fluid being used, the size of the pipes, the pressures and/or temperatures of the systems, or the like, the connector assembly 90 of the present disclosure exhibits a standard deviation of less than 3, 3.5, 4, 4.5, 5, 5.5, 6, 6.5, 7, 7.5, 8, 8.5, 9, 9.5, 10, 10.5, 15, 17, 20, 22, 25, 30, 40, 50 for the seating torque required for establishing the line-seal.

It should be understood that portions of various embodiments of the invention described herein may be combined with other portions of different embodiments of the invention described herein, to form other embodiments of the present that are not specifically disclosed in a single illustrated embodiment, but instead make up one or more combinations of the various embodiments described herein.

It should be understood that when the terms generally or substantially are used herein to describe the orientations of horizontally, vertically, parallel, perpendicular, or the like, the terms mean that the orientations may be +/−1, 2, 3, 4, 4, 5, 10, 15, 20, 25, 30 degrees, or the like, or any range that falls within, overlaps, or is outside of these degrees.

It should be understood that the dimensions described herein may vary by 10, 15, 20, 25, 30, 35, 40, 45, 50, 55, 60, 65, 70, 75, 80, 85, 90, 95, 100, 120, 150, 175, 200, 500, 600, 700%, or the like, or any range that falls within, overlaps, or is outside of these values.

It should be understood that the components herein may be operatively coupled together. Moreover, it should be understood that “operatively coupled,” when used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together.

Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more.”

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A tracer piping system for heating or cooling, the system comprising:
a plurality of tracers, wherein the plurality of tracers are configured to be operatively coupled with one or more components to provide the heating or the cooling of the one or more components using a fluid;
one or more bridge pipes, wherein a bridge pipe is configured to be operatively coupled to two tracers;
wherein a tracer is connected to the bridge pipe through a connector assembly, the connector assembly comprising:
a male connector comprising a male portion provided at one end of the male connector, wherein the male portion comprises:
a conical sealing frustum, wherein the conical sealing frustum comprises a convex face;
a female connector comprising a female portion at one end of the female connector, wherein the female portion comprises:
a female flange having a seat portion, wherein the seat portion has a slanted straight face;
wherein the male connector is operatively coupled to the female connector such that the conical sealing frustum forms a line seal with the seat portion of the female connector for transport of the fluid therethrough.

2. The system of claim 1, wherein the one or more components include a vessel comprising a container or a process pipe.

3. The system of claim 1, wherein the one or more components include a valve, flange, or instrument.

4. The system of claim 1, wherein the connector assembly is a 0.5 inch connector and is torqued to a seating torque of about 30 ft-lb to create the line seal.

5. The system of claim 1, wherein the connector assembly is a 0.75 inch connector and is torqued to a seating torque of about 50 ft-lb to create the line seal.

6. The system of claim 1, wherein the connector assembly is a 1-inch connector and is torqued to a seating torque of about 70 ft-lb to create the line seal.

7. The system of claim 1, wherein the line seal decreases a seating torque when compared to a surface seal by 20 to 40 percent.

8. The system of claim 1, wherein a minimum seating torque for establishing the line seal has a standard deviation of less than 20.

9. The system of claim 1, wherein the male connector is located on the tracer and the female connector on the bridge pipe, or wherein the male connector is located on the bridge pipe and the female connector is located on the tracer.

10. The system of claim 1, wherein the bridge pipe is a pipe or a flexible hose.

11. The system of claim 1, wherein the plurality of tracers have a cross-sectional shape that is generally circular, oval, rectangular, curvilinear, triangular, or a combination thereof.

12. The system of claim 1, wherein the conical sealing frustum with the convex face has a cross-sectional surface when taken along a longitudinal axis that is non-circular.

13. The system claim 1, wherein the male connector or the female connector comprises one or more layers applied to a least a portion of a surface of the male connector or the female connector, wherein the one or more layers comprise a coating or a plating structured to improve one or more surface properties of the male connector or the female connector.

14. The system of claim 1, wherein the fluid is steam, oil, or a predetermined mixture comprising water and glycol.

15. The system of claim 1, further comprising:
one or more jackets located over a portion of the one or more components, wherein the one or more bridge pipes are operatively coupled to the one or more jackets.

16. The system of claim 15, wherein the one or more components are one or more jacketed components comprising a jacketed vessel comprising a container or a pipe, a jacketed valve, a jacketed flange, or a jacketed instrument.

17. A process system for heating or cooling, the system comprising:
one or more jackets, wherein the one or more jackets provide the heating or the cooling to one or more components using a fluid;
one or more bridge pipes, wherein a bridge pipe is configured to be operatively coupled with the one or more jackets;
wherein a jacket is connected to the bridge pipe through a connector assembly, the connector assembly comprising:
a male connector comprising a male portion provided at one end of the male connector, wherein the male portion comprises:
a conical sealing frustum, wherein the conical sealing frustum comprises a convex face;
a female connector comprising a female portion at one end of the female connector, wherein the female portion comprises:
a female flange having a seat portion, wherein the seat portion has a slanted straight face;
wherein the male connector is operatively coupled to the female connector such that the conical sealing frustum forms a line-seal with the seat portion of the female connector for transport of the fluid therethrough.

18. The system of claim 17, wherein the one or more components are a vessel comprising a container or a pipe, a valve, a flange, or an instrument that is heated or cooled by the fluid within the one or more jackets.

19. The system of claim 17, wherein the male connector is located on the jacket and the female connector on the bridge pipe, or wherein the male connector is located on the bridge pipe and the female connector is located on the jacket.

20. The system of claim 17, further comprising:
a plurality of tracers, wherein the plurality of tracers are operatively coupled to the one or more components to provide heating or cooling of the one or more components using the fluid.

21. The system of claim 13, wherein the one or more layers provide corrosion resistance to the male connector or the female connector.

22. The system of claim 13, wherein the one or more layers provide lubrication to improve alignment of the line seal or seating of threads of the male connector and the female connector.

23. The system of claim 13, wherein the one or more layers fill surface abrasions on the male connector or the female connector to improve the line seal.

24. The system of claim 13, wherein the one or more layers provide compressibility for the line seal between the male connector and the female connector.
